(19) United States
(12) Patent Application Publication
(10) Pub. No.: US 2015/0136878 A1
(43) Pub. Date: May 21, 2015

(54) DEVICE FOR INJECTING FUEL

(71) Applicant: Robert Bosch GmbH, Stuttgart (DE)

(72) Inventors: Juergen GRANER, Sersheim (DE); Martin MAIER, Moeglingen (DE); Guenther HOHL, Stuttgart (DE)

(21) Appl. No.: 14/570,171

(22) Filed: Dec. 15, 2014

Related U.S. Application Data
(62) Division of application No. 13/138,121, filed on Sep. 14, 2011.

(30) Foreign Application Priority Data
Jan. 13, 2009 (DE) 10 2009 000 185.9

(51) Int. Cl. F02M 51/06

(52) U.S. Cl. CPC F02M 51/0621; F02M 51/0689
USPC 239/585.1

(57) ABSTRACT

A device for injecting fuel includes an electrodynamic drive having a movably situated coil, an inwardly opening needle which opens and closes injection holes on a valve seat, a connecting element which connects the needle to the movably situated coil, and a pressure chamber which is situated at the needle upstream from the valve seat and contains pressurized fuel.

### CROSS-REFERENCE TO RELATED APPLICATIONS

The present application is a divisional application of U.S. patent application Ser. No. 13/138,121, filed Sep. 14, 2011, which is a national phase to International Application No. PCT/EP2009/065966, filed Nov. 27, 2009, and claims priority to German Patent Application No. 10 2009 000 185.9, filed Jan. 13, 2009, all of which are hereby incorporated by reference in their entireties.

### BACKGROUND OF THE INVENTION

1. Field of the Invention

The present invention relates to a device for injecting fuel, in particular a pressurized fuel being injected into a combustion chamber of an internal combustion engine.

2. Description of Related Art

Known devices for injecting fuel are used, for example, for injecting fuel in vehicle engines. Besides injection of diesel fuel, gasoline is recently also injected. Frequently, for the fuel injection fuel is provided from a storage (rail) and injected into a combustion chamber or an intake manifold via the injection device. Electromagnetic actuators on the one hand, or alternatively, piezoelectric actuators on the other hand, are used as actuators. Electromagnetic actuators are relatively inexpensive, but are relatively slow. On the other hand, piezoelectric actuators are fast but relatively expensive. It would therefore be desirable to have an injection device which has an actuator that is relatively fast and yet inexpensive.

### BRIEF SUMMARY OF THE INVENTION

The device according to the present invention for injecting fuel has the advantage over the related art that it has short switching times and yet is manufacturable in a compact design in a cost-effective manner. The device according to the present invention is also able to easily carry out two or more injections per cycle. The device according to the present invention uses an inwardly opening nozzle, so that a conical spray having a very good pattern is generated during the injection.

In addition, a plurality of spray holes may be easily provided in order to provide individually adjusted sprays, for example for different engine manufacturers, or for a swirl spray. This is achieved according to the present invention in that the device has an electrodynamic actuator or drive having a movable coil. The drive may thus be provided very cost-effectively, and the motion of the coil may be reversed quickly by reversing the direction of the current feed to the coil. The movable coil of the electrodynamic drive is connected to a needle of the injection device, which is implemented with the aid of a connecting element. The connection between the connecting elements of the needle is such that the needle may be actively opened and closed, respectively, by reversing the current direction.

In addition to the movable coil, the electrodynamic drive preferably includes a first permanent magnet and a second permanent magnet, a spacer disk which is situated between the first and second permanent magnets, and a casing which is made of a magnetically conductive material. A very compact and simple design is achieved in this way.

The connecting element which connects the needle to the electrodynamic drive also preferably includes a plurality of fingers. This allows a secure connection between the needle and the electrodynamic drive, and also represents a reliable coupling in both directions of motion. The fingers are preferably connected in a form-locked manner to a pinhole disk which is fixed to the needle.

In addition, the needle preferably includes a closing spring, in particular a spring washer, which is fixed to the needle and which is used for supporting the closing spring. The closing spring assists in a closing operation of the needle.

The injection device also preferably includes a tube which is guided centrally through the electrodynamic drive in the axial direction. The tube is designed to supply fuel through the electrodynamic drive.

A particularly compact design may be achieved in this way.

According to another preferred embodiment of the present invention, the electrodynamic drive is situated in a chamber filled with fuel, the fuel in this chamber being under pressure.

In addition, the device preferably includes a corrugated bellows which separates the electrodynamic drive from the pressurized fuel. As a result, the electrodynamic drive does not have to be situated in a chamber filled with fuel.

To provide a particularly compact design, the needle is provided with a central through hole which is connected via a transverse hole to a pressure chamber at a free end of the needle. Fuel may thus be supplied through the interior of the needle to the pressure chamber.

To achieve the most secure guiding of the needle possible, an end section of the tube is designed as a guide section in order to guide the needle. Separate guide devices for the needle may thus be dispensed with.

According to another preferred embodiment of the present invention, the closing spring is preferably situated in the tube. This allows a particularly compact design of the device in which the closing spring in the tube does not hinder supplying fuel through the tube.

### BRIEF DESCRIPTION OF THE DRAWINGS

FIG. 1 shows a schematic sectional view of a device according to a first exemplary embodiment of the present invention.

FIG. 2 shows a schematic sectional view of a device according to a second exemplary embodiment of the present invention.

FIG. 3 shows a schematic sectional view of a device according to a third exemplary embodiment of the present invention.

### DETAILED DESCRIPTION OF THE INVENTION

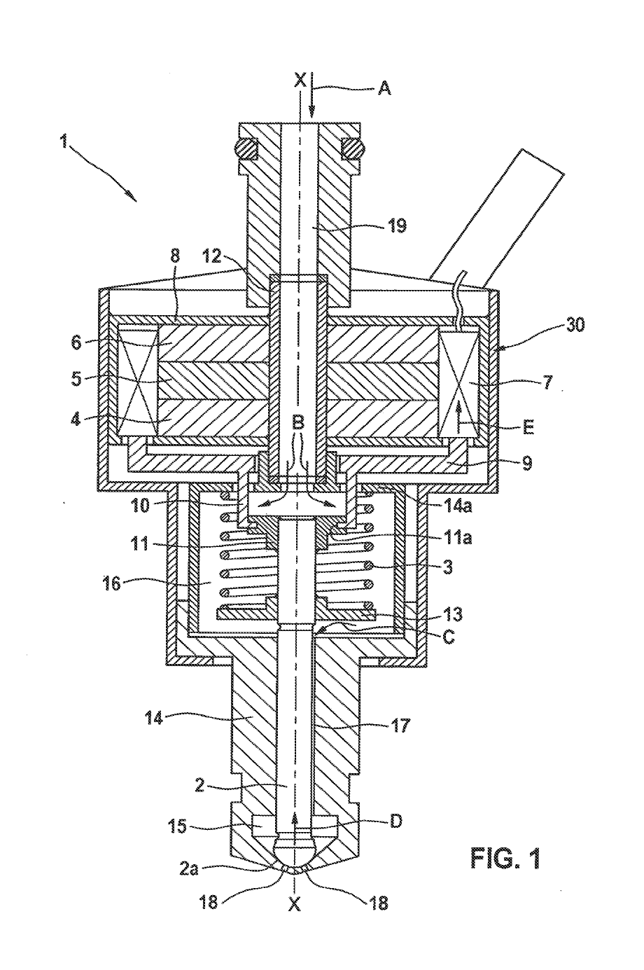

A device 1 for injecting fuel which is under high pressure is described in greater detail below with reference to FIG. 1.

As is apparent in FIG. 1, device 1 includes an electrodynamic actuator 30, a needle 2, and a fuel supply line 19. A fuel under high pressure is supplied to device 1 via fuel supply line 19. Electrodynamic actuator 30 includes a first permanent magnet 4, a second permanent magnet 6, a spacer disk 5, a movable coil 7, and a casing 8. Spacer disk 5 is made of a magnetically conductive material, and is situated between first permanent magnet 4 and second permanent magnet 6. Movably situated coil 7 is situated at the outer periphery of first and second permanent magnets 4, 6 and of spacer disk 5. Casing 8 is likewise made of a magnetically conductive material, and encloses coil 7 at the periphery as well as the two end faces of first permanent magnet 4 and second permanent magnet 6 in axial direction X-X. The two permanent magnets 4, 6 are situated in such a way that the same poles face spacer disk 5. Permanent magnets 4, 6 thus form a magnetic field over spacer disk 5 which extends radially outwardly toward casing 8. When coil 7 is then supplied with current, coil 7 experiences a Lorentz force which, depending on the current direction, acts in an opening or a closing direction of the needle (i.e., in axial direction X-X). This causes coil 7 to move in the appropriate direction in each case.

Device 1 also includes a closing spring 3 which exerts a closing force on needle 2. For this purpose, a spring washer 13 on which closing spring 3 is supported at one end is fastened to needle 2. The other end of closing spring 3 is supported on a housing component 14a. In addition, a pinhole disk 11 is fastened to needle 2, at an end of needle 2 remote from spray holes 18. Spray holes 18 are provided in housing 14 and oriented at a predetermined angle with respect to axial direction X-X. Movable coil 7 is connected to needle 2 via a connecting device 9. Connecting device 9 includes multiple fingers 10 which engage in openings 11a in pinhole disk 11.

In addition, a tube 12 is provided which is guided through electrodynamic actuator 30. Tube 12 is used for conducting fuel from fuel supply line 19. The fuel is led into a fuel chamber 16, flowing between fingers 10 of connecting device 9. This is indicated by arrows B in FIG. 1. Arrow A characterizes the flow direction of the fuel into fuel supply line 19. A rear portion of needle 2 as well as closing spring 3 are situated in fuel chamber 16. In addition, an annular pressure chamber 15 is provided upstream from spray holes 18. Pressure chamber 15 is connected to fuel chamber 16 via a supply line channel 17. Thus, when needle 2 is opened, as indicated by arrow D in FIG. 1, fuel is able to flow from fuel chamber 16 into supply line channel 17, as indicated by arrow C, and from there flows to pressure chamber 15.

Device 1 according to the present invention functions as follows. Fuel which is already under pressure is supplied, as indicated by arrow A, for fuel supply line 19, and tube 12 is supplied to fuel chamber 16. A connection to annular pressure chamber 15 is provided in fuel chamber 16 via supply line channel 17. Electrodynamic actuator 30 is activated if fuel is to be injected. For this purpose, coil 7 is supplied with current in such a way that the coil moves, as indicated by arrow E. Thus, needle 2 also moves in the direction of arrow D, via connecting device 9 and fingers 10. This causes needle 2 to be lifted off from valve seat 2a, thus opening spray holes 18 and allowing fuel to be injected from the spray holes into a combustion chamber or an intake manifold. Closing spring 3 is compressed by the motion of needle 2. To conclude the injection, the current direction at movable coil 7 is reversed, causing the coil to move in the opposite direction. Active closing of needle 2 is thus achieved, with the assistance of tensioned closing spring 3 in the closing operation. Needle 2 is thus actively closed as a result of the fixed connection between movable coil 7 and needle 2. The injection of fuel is thus concluded.

According to the present invention, for an inwardly opening valve, needle 2 may thus be actively opened and closed, using an electrodynamic actuator 30, by reversing the current direction at a movable coil 7. Very brief closing times may be achieved which are significantly shorter than closing times for electromagnetic actuators, for example. This is achieved with a compact design of device 1 as well as very cost-effective manufacturability of device 1. By providing a plurality of spray holes 18, large quantities of fuel may be injected, even with short opening times. In particular, a spray with very good distribution may thus be achieved.

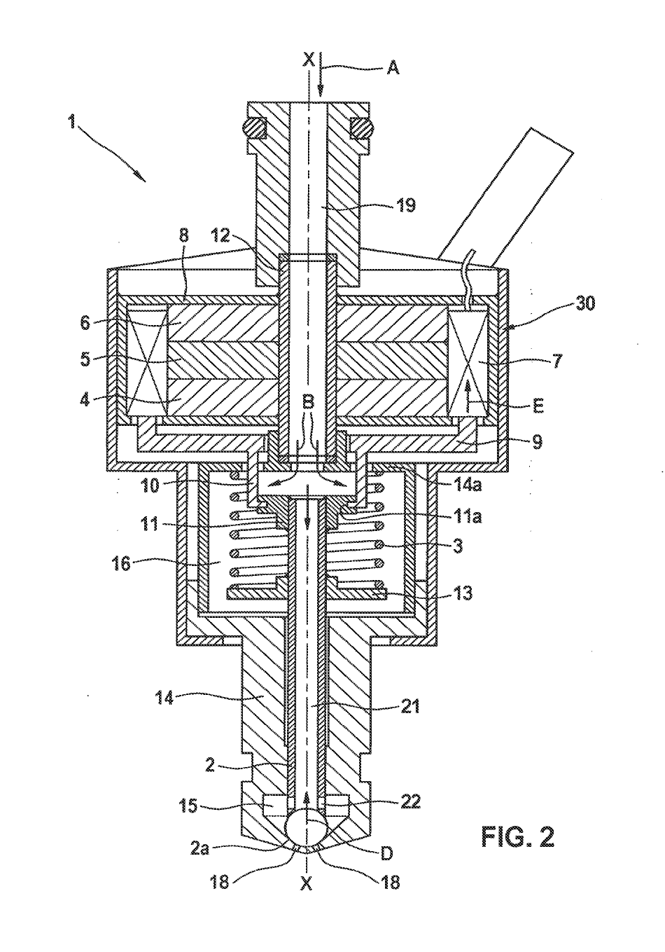

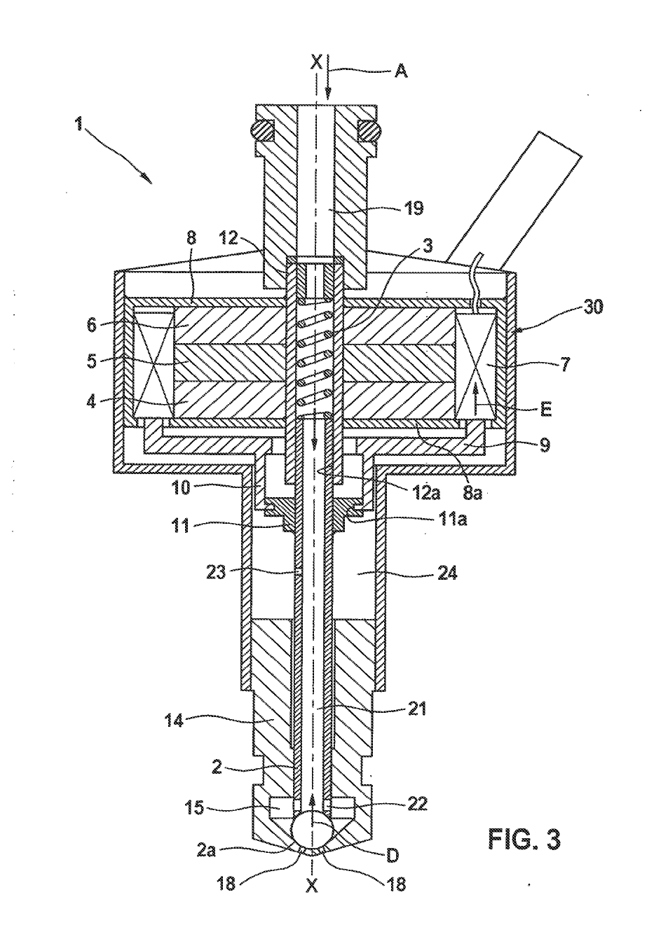

Further preferred exemplary embodiments of the present invention are described in greater detail below with reference to FIGS. 2 and 3. Identical or functionally equivalent parts are denoted by the same reference numerals as in the first exemplary embodiment.

FIG. 2 shows a device 1 according to a second exemplary embodiment, except that, in contrast to the first exemplary embodiment, in the second exemplary embodiment the fuel is supplied to annular pressure chamber 15 via a central needle hole 21 and a transverse hole 22. Thus, fuel may be conducted through entire device 1 to annular pressure chamber 15 without large pressure losses. Electrodynamic actuator 30 is centered over housing region 14a on which tube 12 is supported, electrodynamic actuator 30 being fixed to tube 12.

FIG. 3 shows a device 1 according to a third exemplary embodiment which essentially corresponds to the second exemplary embodiment. In contrast to the second exemplary embodiment, in the third exemplary embodiment no fuel chamber 16 is present. The fuel is conducted in the axial direction by fuel supply line 19, through tube 12 and central through hole 21 as well as transverse holes 23, to annular pressure chamber 15. Closing spring 3 is situated in tube 12. In addition, tube 12 has a guide section 12a, at the end facing needle 2, on which needle 2 is guided. Tube 12 itself is centered over a base region 8a of casing 8. A further transverse hole 22 also provided in needle 2 establishes a connection to a second pressure chamber 24. This connecting hole 22 thus ensures that electrodynamic actuator 30 itself is situated in the fuel.

As the result of using electrodynamic actuator 30, device 1 described in the exemplary embodiments thus has characteristics which very closely approximate the characteristics of piezoelectric actuators. Named in particular are a very short switching time and multiple injections during a cycle. Devices 1 according to the present invention are nevertheless very compact and cost-effective.

1-10. (canceled)

11. A device for injecting fuel, comprising:
an electrodynamic drive having a movably situated coil;
an inwardly opening needle configured to open and close injection holes on a valve seat;
a connecting element which connects the needle to the movably situated coil; and
a pressure chamber situated at the needle upstream from the valve seat and containing pressurized fuel, wherein the electrodynamic drive is situated in a fuel chamber filled with fuel.

12. The device as recited in claim 11, further comprising:
a corrugated bellows separating the electrodynamic drive from the pressurized fuel.

13. The device as recited in claim 11, wherein the needle includes a central through hole connected to the pressure chamber via at least one transverse hole.

14. The device as recited in claim 11, further comprising a tube which is guided through the electrodynamic drive, wherein:
the fuel is supplied through the tube, and
an end section of the tube is configured as a guide section for the needle in order to guide the needle in an axial direction.
